(19) United States
(12) Patent Application Publication
(10) Pub. No.: US 2011/0277358 A1
(43) Pub. Date: Nov. 17, 2011

(54) Anti-photo radar license plate attachment

(76) Inventor: Terence Richard Iceton, Penticton (CA)

(21) Appl. No.: 12/662,923

(22) Filed: May 12, 2010

(51) Int. Cl. B60R 13/10

(52) U.S. Cl. 40/209

(57) ABSTRACT

A anti-photo radar licence plate attachment includes a base and a fin. The base is adapted for mounting to a vehicular licence plate, at one end only of the vehicular licence plate so as to be substantially parallel with and flush with the licence plate. The fin is mounted to or formed as part of the base along a common edge between the fin and the base so as to extend substantially orthogonally from the base. The fin is substantially vertically oriented when the base is mounted to licence plate, and inclined over the licence plate so that a photo radar camera at roadside viewing the licence plate at an acute angle has its view of the character or digit on the licence plate closest to the fin blocked by the fin.

### FIELD OF THE INVENTION

This invention relates to the field of devices for inhibiting the operation of so-called photo radar systems employed to capture images of motor vehicle licence plates contemporaneously with detection of a traffic violation, and in particular, to an anti-photo radar licence plate attachment which extends over only one end of a licence plate so as to partially impede the view of only that end of the licence plate to photographic equipment forming part of the photo radar system arranged along the roadside to photograph the licence plate at an acute angle to the direction of travel of the motor vehicle.

### BACKGROUND OF THE INVENTION

Many jurisdictions employ semi-automated traffic violation detection systems employing so-called photo radar in which for example conventional radar speed detection devices cooperate with a photographic system so that upon detection of a traffic violation by the radar system, the photographic system attempts to photograph the front or rear licence plate of the vehicle which has committed the traffic violation.

In many instances, the photographic system is mounted along the roadside immediately adjacent the shoulder of the road and includes a camera angled at an acute angle, for example 20-24 degrees, and in particular 22.5 degrees, relative to the direction of travel of the vehicle so that the camera in conjunction with typically a photographic flash lighting system, photographs the vehicle licence plate at a preferred distance from the camera. The arrangement is intended to place the vehicle licence plate within the field of view of the camera so that the image is in focus and not blocked by other traffic, and may be later read by an analyst to determine the licence plate number on the photographed licence plate. If the analyst can clearly read the licence plate number then a traffic violation ticket will be issued to the owner of the motor vehicle which has been photographed.

If the analyst cannot clearly determine from the photographed image each and every digit and character of the licence plate number on the licence plate, the analyst may pass over that photograph and not issue a traffic violation ticket. Consequently, applicant has determined that if only one end of the licence plate number is blocked from the field of view of the camera in the photo radar photographic system, and without impeding the straight on view of the licence plate, so that the resulting photograph taken by the camera does not have a clearly viewable image of the number or character at only one end or the other of the licence plate being photographed, then a traffic violation ticket may not issue as a result of the photograph of the licence plate.

In the prior art, applicant is aware of published United States patent application by DeGroote, publication number US2004/0159023 which was published Aug. 19, 2004 for a Licence Plate Loover. DeGroote discloses an arrangement of horizontal slats which are attached at their ends to vertical strips so as to create a licence plate louver. The slats are described as being solid and horizontally arranged similar to a mini blind so that a clear view of the licence plate is obtained from straight on to the licence plate but that the slats cannot be seen through from above or from an abrupt angle so as to prevent unauthorized photos being taken of the licence plate from above or from the abrupt angle. DeGroote describes the slats as interfering with the resolution of a photograph of the licence plate by shading many sections of the licence plate.

Applicant is also aware of U.S. Pat. No. 6,006,459 which issued Dec. 28, 1999, to Kosmach for a Vehicle Licence Plate Cover. Kosmach teaches a transparent licence plate cover member having an outwardly projecting curved shape so as to closely approximate the particular vehicle body shape where attached. The licence plate cover may be clear or tinted. The installed licence plate cover serves to block the cavity ordinarily found at such vehicle licence plate locations.

### SUMMARY OF THE INVENTION

In summary, the anti-photo radar licence plate attachment according to the present invention may be characterized as including a base and a fin where the base is adapted for mounting to a vehicular licence plate, at one end only of the vehicular licence plate, so as to be substantially parallel with and flush with the licence plate, and the fin is mounted to the base along a common edge therebetween so as to extend substantially orthogonally from the base and wherein the fin is substantially vertically oriented when the base is mounted to licence plate.

The fin has a height and a set back. The fin includes a distal edge which is distal from the base. The fin is cantilevered from the base. The height is a height dimension measured from substantially the base to the distal edge. The fin is inclined over the base and over the licence plate when the base is mounted to the licence plate. The setback is a setback dimension measured orthogonally from a plane which is orthogonal to the base and contains the common edge. The setback is the distance from the plane to the distal edge of the fin.

The height and the setback of the distal edge provides an occlusion zone in a penumbra of the fin. That is, the occlusion zone is between the distal edge of the fin and the base. The occlusion zone is also between the distal edge and a first adjacent character or digit of the licence plate number on the licence plate adjacent the fin when the base is mounted on the licence plate.

The occlusion zone occludes the view of the first adjacent character or digit when viewed along a line-of-sight from a distant roadside position at an acute angle formed between the plane and the line-of-sight, wherein the distant roadside position is a photo-radar camera position adjacent a road along which a vehicle carrying the licence plate and the licence plate attachment is travelling. The line-of sight is limited by the distal edge of the fin so as to bound a side opposite the fin of the occlusion zone on the first adjacent character or digit or the licence plate.

Advantageously the base and the fin form substantially an L-shape. In one embodiment the fin has a substantially planar portion adjacent the common edge and has an inclined portion between the planar portion and the distal edge. The inclined portion is inclined from the plane by an inclination angle, which may be substantially 20-24 degrees and in particular may be advantageously 22.5.

The height dimension may be substantially 10 centimetres. The common edge may be substantially 13 centimetres long. The distal edge may be of substantially the same length as the common edge. The base may include a pair of arms, which for example may form a C-shape. Mounting apertures may be formed in the arms.

The anti-photo radar method according to the present invention includes providing a anti-photo radar licence plate attachment having:
a base and a fin where the base is adapted for mounting to and advantageously behind, a vehicular licence plate, at one end only of the vehicular licence plate, so as to be substantially parallel with and flush with the licence plate, and where the fin is mounted to the base along a common edge therebetween so as to extend substantially orthogonally from the base and where the fin is substantially vertically oriented when the base is mounted to licence plate,
and where the fin has a height and a set back, and where the fin includes a distal edge which is distal from the base, and where the fin is cantilevered from the base, and where the height is a height dimension measured from substantially the base to the distal edge, and where the fin is inclined over the base and over the licence plate when the base is mounted to the licence plate, and where the setback is a setback dimension measured orthogonally from a plane which is orthogonal to the base and contains the common edge, and where the setback is the distance from the plane to the distal edge of the fin.
and where the height and the setback of the distal edge are provided so that an occlusion zone is formed in a penumbra of the fin, that is, in the occlusion zone between the distal edge of the fin and the base, and where the occlusion zone is also between the distal edge and a first adjacent character or digit of the licence plate number on the licence plate adjacent the fin when the base is mounted on the licence plate,
and where the occlusion zone occludes substantially the view of the first adjacent character or digit of the licence plate when viewed along a line-of-sight from a distant roadside position at an acute angle formed between the plane and the line-of-sight, wherein the distant roadside position is a photo-radar camera position adjacent a road along which a vehicle carrying the licence plate and the licence plate attachment is travelling, and where the line-of sight is limited by the distal edge of the fin so as to bound a side opposite the fin of the occlusion zone on the first adjacent character or digit of the licence plate.

### BRIEF DESCRIPTION OF THE DRAWINGS

In the following figures wherein like characters of reference denote corresponding parts in each view:

FIG. 1 is, in perspective view, one embodiment of the anti-photo radar licence plate attachment according to the present invention.

FIG. 2 is, plan view, the licence plate attachment of FIG. 1 mounted behind a licence plate shown partially cut-away.

FIG. 3a is, in rear elevation view, the licence plate attachment of FIG. 1.

FIG. 3b is, in front elevation view, the licence plate attachment of FIG. 1.

FIG. 3c is, in right side elevation view, the licence plate attachment of FIG. 1.

FIG. 3d is, in left side elevation view, the licence plate attachment of FIG. 1.

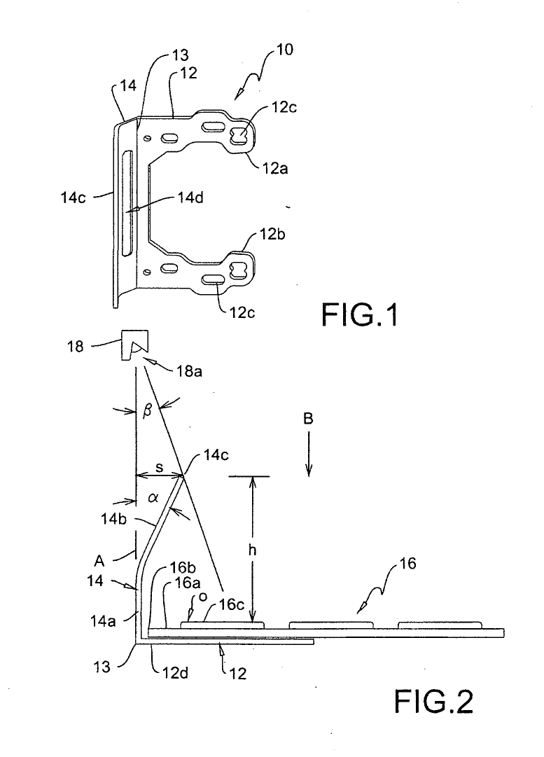

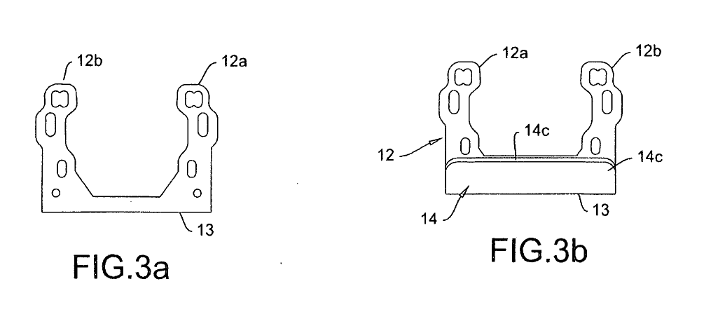

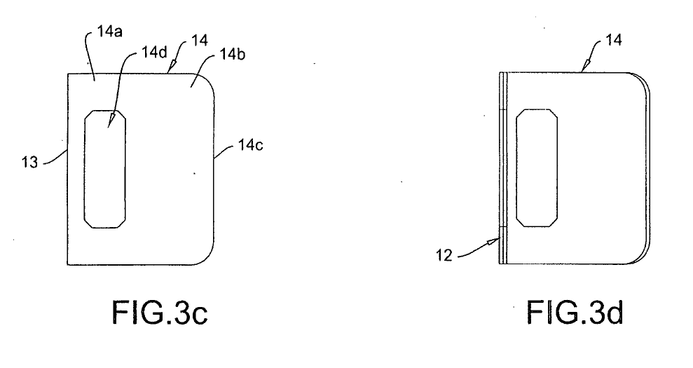

### DETAILED DESCRIPTION OF EMBODIMENTS OF THE INVENTION

The anti-photo radar licence plate attachment according to the present invention is formed as an L-shape so that a base flange of the L-shape mounts underneath that is, behind, a licence plate so as to provide a secure base supporting the other, generally perpendicularly extending flange or fin so that the fin protrudes cantilevered from the base flange at right angles to the licence plate. The fin is a single flange of the L-shaped attachment which then extends outwardly from one end of the licence plate so as to block the field of view of a photo radar camera viewing the licence plate from an acute angle at roadside. The fin blocks at least partially the view of the camera of the last character or digit of the licence plate number on the licence plate, that is, the character or digit most closely adjacent to the fin. In this fashion, the camera when it takes a photo of the licence plate only records an incomplete licence plate number.

Thus as seen in the Figures, anti-photo radar licence plate attachment 10 includes a base flange 12 and a fin or cantilevered flange 14. Base flange 12 includes spaced apart generally parallel arms 12a and 12b having an arrangement of mounting apertures 12c formed therein. The arrangement of mounting apertures may be varied and still remain within the intended scope of the present invention. However, the arrangement as illustrated reflects in applicant's view sufficient mounting apertures to fit the fastener patterns and dimensions found in licence plates from many jurisdictions. The arrangement of the arms and apertures may of course be varied to meet the particular requirements of the dimensions and fastener arrangements of licence plates in any jurisdiction.

Cantilevered flange 14 includes, in the illustrated embodiment which is not intended to be limiting, adjacent flange section 14a which is mounted or formed rigidly at right angles along a common edge 13 of base flange 12. An inclined section 14b is mounted or formed so as to extend from adjacent section 14a at an angle relative to or curving out of the plane A of adjacent flange 14a. Inclined section 14b is inclined over adjacent section 12d of base flange 12.

Base flange 12 mounts underneath one end 16a of licence plate 16 so that common edge 13 runs closely along, parallel to, edge 16b of licence plate 16.

Inclined section 14b of cantilevered flange 14 advantageously curves inwardly from plane A and over end 16b or is formed as a bend where it intersects adjacent section 14a so as to form an angle alpha between plane A and inclined section 14b. In one embodiment not intended to be limiting, angle alpha may be approximately 22.5 degrees. Angle alpha, combined with the height dimension h and the setback dimension s of edge 14c of cantilevered flange 14 dictates the occluded area o and in particular the size of the occluded area o on end 16a of licence plate 16. Occluded area o is the area in the penumbra formed under the fin 14 within the field of view 18a of a roadside camera 18. Camera 18 typically photographs licence plate 16 at an angle β of typically 22.5 degrees relative to the normal direction of travel B of the vehicle to which licence plate 16 is mounted. Direction B of travel will be substantially parallel to plane A. Thus, the objective is that occluded area o will include most or all of the end-most character or digit 16c of the licence plate number on licence plate 16 so that a photograph taken by camera 18 will not show any or enough of character or digit 16c for an analyst reviewing the photograph to issue a traffic violation ticket to the owner of the vehicle corresponding to licence plate 16.

Attachment 10 may be manufactured of rigid or semi-rigid plastic, for example manufactured via an injection moulding process. The mounting arms 12a and 12b are provided, working in conjunction with the bend formed along common edge 13 so that attachment 10 may be mounted behind a licence plate 16 using either one or two mounting screws or bolts (not shown). As stated above, the intention is to prevent the last character or digit 16c on licence plate 16 from being successfully photographed by for example a photo radar photographic system or by a red traffic light sensing photo system or the like (generically referred to herein as photo radar).

Base flange 12 and in particular arms 12a and 12b are substantially co-planar and flat and may, as illustrated form a C-shape having ten apertures 12c formed therein, where two of the apertures are round and eight of the apertures are oval, and wherein four of the oval apertures are overlapping side-by-side. In one embodiment, the C-shape of base flange 12 has dimensions of approximately 9.7 centimetres by 14.1 centimetres and is intended to substantially fully mount behind licence plate 16 so that base flange 12 is not visible from straight-on, being sandwiched between the rear of the licence plate 16 and the motor vehicle (not shown).

Cantilevered flange 14 may in one embodiment, have dimensions of approximately 10.2 centimetres by 13 centimetres. Thus the “fin” protrudes 10.2 centimetres from base flange 12, that is, dimension h is substantially 10 centimetres. When attachment 10 is installed behind licence plate 16, adjacent section 14a extends substantially perpendicularly from licence plate 16, and attachment 10 extends approximately 13 centimetres measured vertically along edge 16b of licence plate 16.

Advantageously, a licence plate light aperture 14d is formed in cantilevered flange 14, for example, having dimensions of 3 centimetres by 8 centimetres so as to allow the vehicle's licence plate light (not shown) to illuminate licence plate 16 through aperture 14d.

In a preferred embodiment, adjacent section 14a extends approximately 4 centimetres out from the plane of base flange 12, and inclined section 14b bends or curves inwardly at substantially a 22.5 degree angle alpha. Setting angle alpha at generally a 22.5 degree incline provides for sufficient coverage of occlusion area o so as to block the view of digit or character 16c while still allowing a good and mostly unobstructed view of digit or character 16c when viewed straight onto licence plate 16, that is when viewed in direction B parallel to direction of travel of the vehicle.

In a preferred embodiment, the outer corners of the “fin” or inclined section 14b are rounded to reduce any hazard presented by the “fin”. The “fin” may be colored either black or to blend in with the vehicle's color.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An anti-photo radar licence plate attachment comprising:
a base adapted for mounting to a vehicular licence plate, at one end only of the vehicular licence plate, so as to be substantially parallel with and flush with the licence plate,
a fin mounted to said base along a common edge so as to extend substantially orthogonally therefrom and wherein said fin is substantially vertically oriented when said base is mounted to licence plate,
wherein said fin has a height and a set back, wherein said fin has a distal edge distal from said base, said fin being cantilevered from said base, and wherein said height is a height dimension from substantially said base to said distal edge, and wherein said fin is inclined over said base and over the licence plate when said base is mounted to the licence plate, and wherein said setback is a setback dimension measured orthogonally from a plane, said plane orthogonal to said base and containing said common edge, to said distal edge,
and wherein said height and said setback of said distal edge provides an occlusion zone in a penumbra of said fin, said occlusion zone between said distal edge and said base, and between said distal edge and a first adjacent character or digit on the licence plate adjacent said fin when said base is mounted on the licence plate,
wherein, when viewed along a line-of-sight from a distant roadside position at an acute angle formed between said plane and said line-of-sight, wherein said distant roadside position is a photo-radar camera position adjacent a road along which a vehicle carrying the licence plate and said licence plate attachment is travelling said line-of sight as limited by said distal edge bounding a side opposite said fin of said occlusion zone on the first adjacent character or digit or the licence plate when said base is mounted on the licence plate.

2. The device of claim 1 wherein said base and said fin form substantially an L-shape.

3. The device of claim 2 wherein said fin has a substantially planar portion adjacent said common edge and has an inclined portion between said planar portion and said distal edge, inclined from said plane by an inclination angle.

4. The device of claim 3 wherein said inclination angle is substantially 22.5 degrees.

5. The device of claim 4 wherein said height dimensions is substantially 10 centimetres.

6. The device of claim 5 wherein said common edge is substantially 13 centimetres long.

7. The device of claim 6 wherein said distal edge is of substantially the same length as said common edge.

8. The device of claim 2 wherein said base includes a pair of arms.

9. The device of claim 8 wherein said pair of arms form a C-shape and wherein mounting apertures are formed in said pair of arms.

10. An anti-photo radar method comprising:
a) providing an anti-photo radar licence plate attachment having:
a base adapted for mounting to a vehicular licence plate, at one end only of the vehicular licence plate, so as to be substantially parallel with and flush with the licence plate,
a fin mounted to said base along a common edge so as to extend substantially orthogonally therefrom and wherein said fin is substantially vertically oriented when said base is mounted to licence plate,
wherein said fin has a height and a set back, wherein said fin has a distal edge distal from said base, said fin being cantilevered from said base, and wherein said height is a height dimension from substantially said base to said distal edge, and wherein said din is inclined over said base and over the licence plate when said base is mounted to the licence plate, and wherein said setback is a setback dimension measured orthogonally from a plane, said plane orthogonal to said base and containing said common edge, to said distal edge,
and wherein said height and said setback of said distal edge provides an occlusion zone in a penumbra of said fin, said occlusion zone between said distal edge and said base, and between said distal edge and a first adjacent character or digit on the licence plate,
b) providing said height and said setback dimensions so that, when viewed along a line-of-sight from a distant roadside position at an acute angle formed between said plane and said line-of-sight, wherein said distant roadside position is a photo-radar camera position adjacent a road along which a vehicle carrying the licence plate and said licence plate attachment is travelling said line-of sight as limited by said distal edge bounding a side opposite said fin of said occlusion zone on the first adjacent character or digit or the licence plate when said base is mounted on the licence plate.

11. The method of claim 11 including the further step of mounting said base behind the licence plate at only one end of the licence plate, the only one end being that end closest to the roadside, and so as to extend said fin inclined over the licence plate.
